(19) United States
(12) Patent Application Publication
(10) Pub. No.: US 2014/0333045 A1
(43) Pub. Date: Nov. 13, 2014

(54) Ergonomic Wheelchair With Ventral Support

(71) Applicants: Luis Sananes, Mendoza City (AR); Renzo Bucca Puy, Mendoza City (AR); Matias Fernando Canton, Mendoza City (AR)

(72) Inventors: Luis Sananes, Mendoza City (AR); Renzo Bucca Puy, Mendoza City (AR); Matias Fernando Canton, Mendoza City (AR)

(21) Appl. No.: 14/274,514

(22) Filed: May 9, 2014

(30) Foreign Application Priority Data
May 10, 2013 (AR) 20130101631

(51) Int. Cl. A61G 5/12

(52) U.S. Cl. CPC A61G 5/12
USPC 280/281.1

(57) ABSTRACT

An ergonomic wheelchair with ventral support has an ergonomic shape where the person is placed in a position with support areas at the person's frontal area. The wheelchair is provided with a frame made of a reticular structure as a main support, mounted over four wheels, with the two rear wheels being much smaller and free to move in any direction. The structure has three main support surfaces: thoracic, femoral and tibial, each perfectly padded to achieve a proper distribution of pressure. The thoracic level can vary its length and inclination, the tibial support surface can modify its verticality, and the support surface of the thighs can be regulated for better anthropometric suitability. It is equipped with armrests for when the vehicle is self-propelled, and has two handles to allow another person to push it. A headrest with a visor avoids the tensions of having to hold the head up.

This application is based upon and claims the benefit of priority from prior Argentina Application 20130101631 filed May 10, 2013, the entire contents of which are incorporated herein by reference.

### TITLE AND TECHNICAL FIELD OF THE INVENTION

This invention refers to a type of ergonomic wheelchair with ventral support designed for people that have the need to use a wheelchair, but cannot use one because of injuries or conditions that prevent them from doing so. These individuals will now have the possibility of a different support option that will help them prevent injuries, carry on physical therapy and continue with everyday life.

### TECHNICAL STATUS AND PROBLEMS TO BE SOLVED

It is known that when moving people who have injuries or conditions that prevent them from travelling by themselves, there are different models of wheelchairs known for everyday use or to use during a given period of time while they can't walk. They are generally provided with a seat with backrest, headrest, feet rest and leg rest, and they generally have 4 wheels, two large ones in the back and two smaller ones in the front, that enable spinning and are activated manually or with some sort of motor to propel them. In the case of regular wheelchairs, the user is positioned in a normal sitting position, resting in his/her back, that is to say, sitting on his/her bottom and resting with his/her back on the backrest of the chair. This is why the extended use of these chairs may produce injuries due to “longstanding recumbency or support” in a generally bony area of the body, risking the tissues and/or with a possibility of developing necrosis due to ischemia caused mainly by a constant pressure that hinders the blood circulation in the area. Most people with spinal cord injuries require a wheelchair to travel independently and carry on with work, education, or social activities, and they usually spend somewhere between 12 to 15 hours a day in this position. This prolonged use of wheelchairs can produce a series of injuries and physical conditions, and this is one of the reasons why people with spinal cord injuries are considered the most vulnerable group to develop pressure sores due to immobility and insensitivity, among other factors. Some researchers estimate that between 50 and 80% of people with spinal cord injuries develop pressure sores, the most common location this condition affects are the following: scapulas, iliac crest, sacrum, trochanters, sit bones, and the popliteal area. About 10% of the world population (around 650 million people) has disabilities, out of which 10% need a wheelchair; so it is estimated that 1% of the total population (or 10% out of the people with disabilities) need wheelchairs, i.e. about 65 million people worldwide. On the other hand, the Veterans Administration (VA) has estimated that 40% of paraplegic and 50% of quadriplegic people require hospitalization due to complications from pressure sores during their lifetime. Because the occurrence of these injuries precludes the use of their primary means of travel, the wheelchair, the disabled person sees every aspect of his/her life prominently disturbed by it. Nowadays, there are different ways to reduce or prevent pressure sores, the most common focus on the distribution of the pressures in order to minimize them in the most challenging areas through the use of cushions, for example, which are compressed in the bony areas and firmer in areas of lower risk; but this does not always release the pressure on the mentioned areas in order to allow the blood circulation, nor it guarantees a good posture. They also have another drawback: they retain moisture, an element that favors pressure injuries, since they hinder the ventilation in the affected area. Other methods use pneumatic or hydraulic pressure to control the pressure pad, but these methods have the disadvantage of requiring pressure sources and, therefore, some form of power supply, besides the fact that they do not favor proper ventilation. There are other chairs that have a system that controls the time the person spends in the same position, or others that adopt a method of standing, thereby changing the support areas.

### SUMMARY OF THE INVENTION

As it was detailed in the previous section, this invention is designed to solve problems for people who, due to some sort of spinal cord injury and/or condition or trauma caused in their body, cannot stand on their own, so they are forced to use wheelchairs, and the use thereof produces other injures due to prolonged decubitus or support in areas of the body that are usually bony, so the main purpose is to prevent problems with the tissue and/or the appearance of ischemic necrosis caused mainly by the pressure in the areas given by the position taken in the chair, because of its shape. For this reason we have built an ergonomic wheelchair with ventral support, with an ergonomic shape that is totally different from the classical wheelchair, and where the person is placed in a position where the support areas are significantly different than the regular wheelchair, changing them from the person's back area to the frontal area. To achieve this, the wheelchair is provided with a frame made up of a reticular structure as the main support, mounted over four wheels, being the two frontal bigger and having a push rim included, and the two rear wheels being much smaller and directionally free to move in any direction. The structure has three main support surfaces: thoracic, femoral and tibial, all three perfectly padded to achieve a proper distribution of the pressure, the thoracic level can vary its length and inclination, in order to prevent fatigue and change positions, and also to help the person stand up. The tibial support surface can modify its verticality, and the support surface of the thighs can be regulated for better anthropometric suitability. It is equipped with armrests for those moments when the vehicle is being self-propelled, and it has two handles or rear supports to allow another person to push it; it also has a headrest with a visor or periscope that avoids the tensions of having to hold the head up in order to look forward.

### DRAWINGS AND SPECIFICATIONS

In order to have a better and more complete understanding of this invention, the following illustrations are attached:

FIG. 1 is a trimetric perspective;

FIG. 2 is a right side or right profile view;

FIG. 3 is an exploded view of the invention; and

FIG. 4 is a perspective view with the person placed on the chair in ventral position.

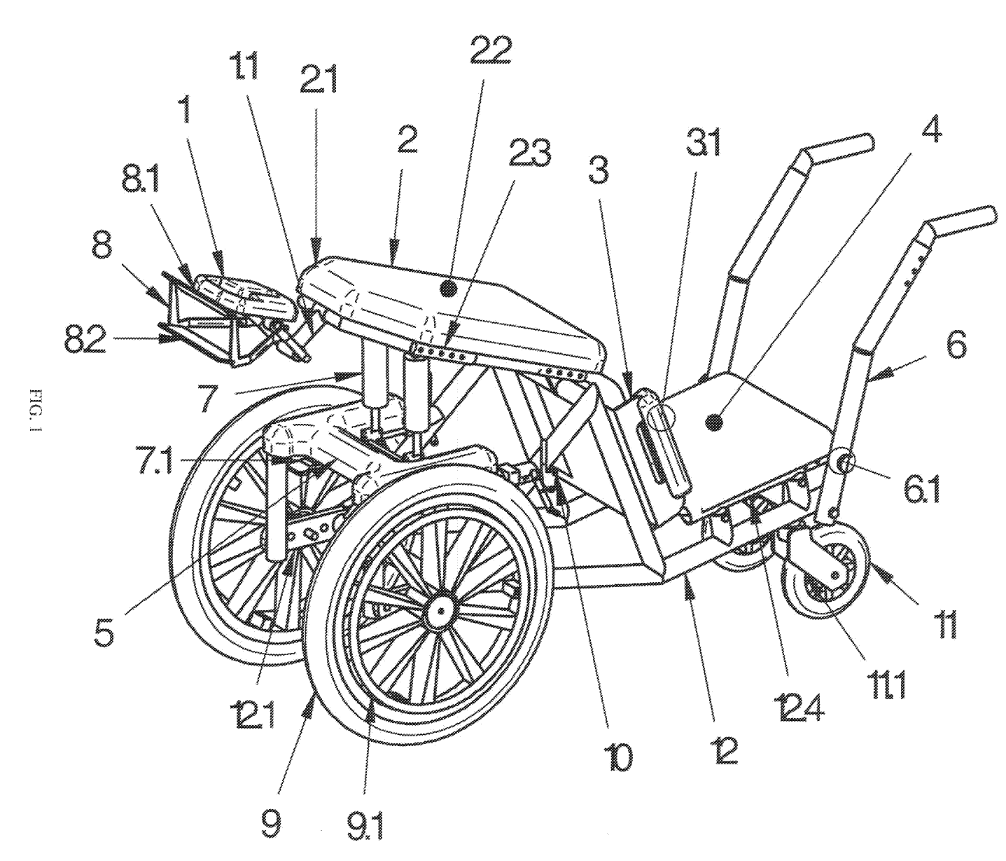

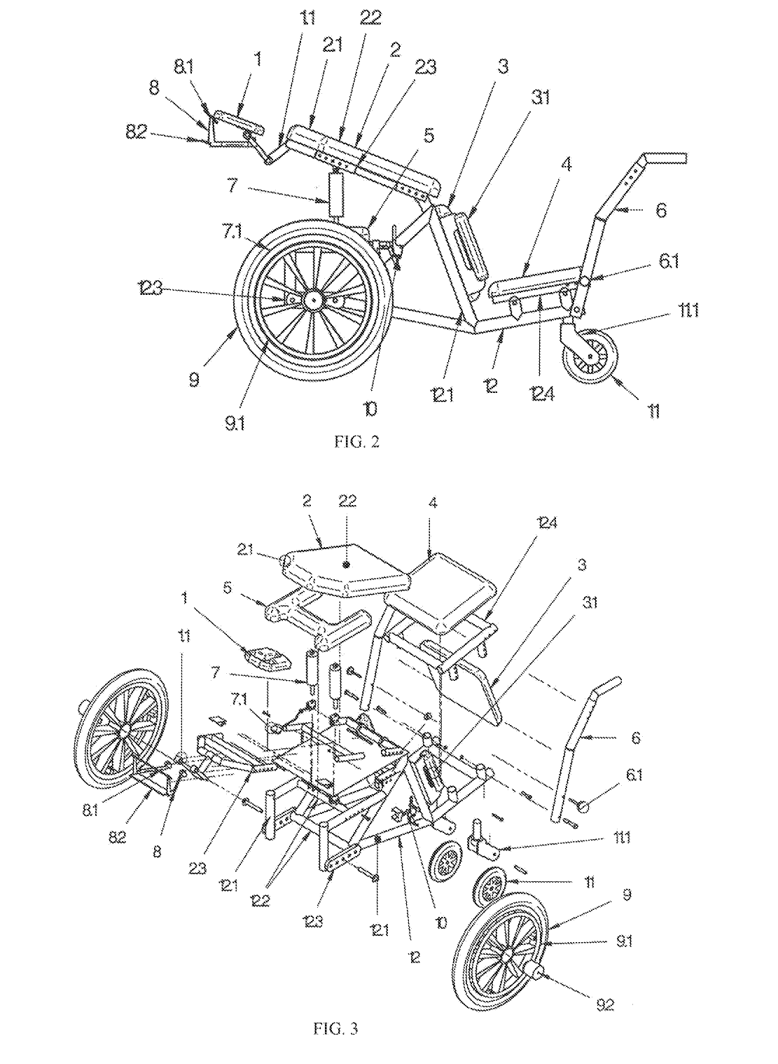

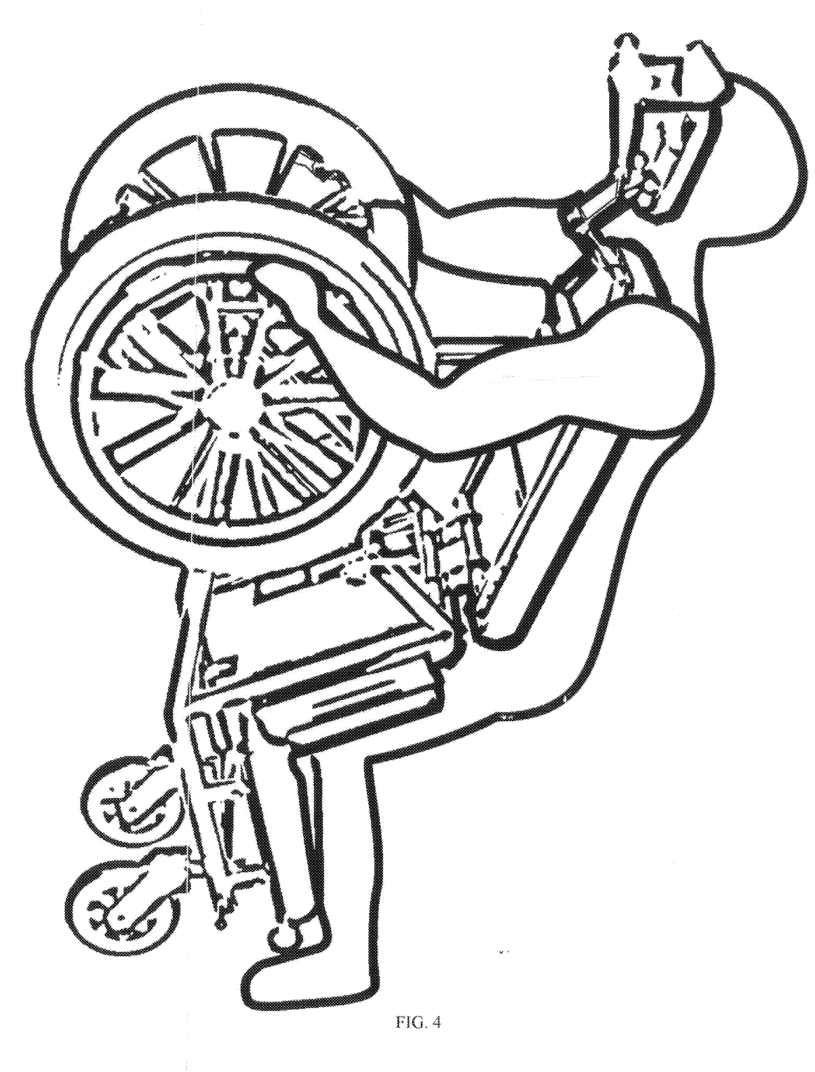

We must remember that the position taken by the user of this ergonomic chair is with a ventral support, i.e. face down, resting on the chest, upper abdomen and knees, so this invention consists of a reticular or frame support (12) that consists of two parallel reticular structures preferably with a tubular shape (12.1), linked together by cross bars (12.2), where the other elements of the chair are supported, all placed over four wheels, two larger frontal ones (9) and two rear ones (11) that are much smaller and rotate directionally. On top of the wheels there is a structure formed by five main parts: a support surface for the head (1), another for the ventral-thoracic support (2), another for the femoral support (3), another for the tibial support (4), and finally the support for the arms (5). The description for these parts states that the support surface (1) is a platform for supporting the head of the person that is lying in horizontal or recumbent position, supported by a latch (1.1) that links to the frame (12) and that is articulated and ring-shaped in order to vary its position, so that the person positions the head facing the ground and resting the edges of the face to prevent the torsion of the neck, leaving the nose, eyes and mouth exposed; a support surface (2) for the chest and belly with a position that is slightly tilted back, and which consists of an adjustable reticular system for different anthropometries and is provided with a padded surface (2.2) that rests on the tubular support (2.3) that is also linked to the headrest (1), all supported over the frame (12). The support surface (2) pivots by its rear end, which allows a variation of the angle of inclination, for which it has been provided with two vertical pneumatic cylinders (7) fixed over the frame (12) and to the top of the base (2.3) of the support surface (2) and activated by a lever (7.1) located within easy reach in front of the support arm (5) and which back ends have a form that is suitable for the free use of the arms with a large oblique cutout. In the center of the ventral-thoracic support surface (2.2), in the part where the respiratory tract and the stomach are supported, there is a different density than on the surrounding padding (2.1) to make the expansion of the chest and stomach for breathing easier, and it can also be provided with ventilation perforations. As regards the support surface (3), it is a stable padded semi-vertical inclined surface designed to provide a suitable pressure on the thighs, and provided with removable lateral supports (3.1) for a better containment of the lower limbs, which are used as handles for transfers, such as when moving from a wheelchair to the invention and vice versa, and which are linked to the frame (12) and have a length regulation from the movement of the tibial support surface. Next to it (4) there is a stable surface in semi-horizontal position with a forward tilt fixed to the frame through the square reticle (12.4), which is also padded for proper distribution of the pressure on the front of the legs that rest on it. The armrest (5) with an H shape is positioned horizontally, and it is also padded, and it supports the frontal area of the arms, wrists and hands, when they are at rest, and it also works as a support to help when sitting up, push out, and getting out of the chair. The handles (6) are formed by two poles fixed in the back of the seat through two quick release latches (6.1) fixed to the frame (12) and the base (12.4) of the support surface (4), and their function is that another person may use them to push and control the travelling of the user. To avoid fatigue of the muscles on the neck of the person due to the position of the body and head when looking forward, the support surface has a built in (1) visor or periscope (8) that consists of mirrors (8.1) and (8.2) has angles that make viewing in different directions easier, especially when looking forward, avoiding painful muscle contractions when lifting the head in order to look forward. The frame (12) and all other accessories are supported, as previously explained, over two front wheels (9) provided with two separate thrust rings (9.1) located on the outside of the wheels and which serve to help the user to propel itself, taking advantage of the ergonomic positioning of the person face down on the chair, which causes the moment applied to the ring to be very effective, and they may also be provided with two separate cranks (9.1) secured to the outer part of each ring (9.1) to facilitate self-propelling. Also, these wheels are fixed to the structure through two brackets (12.3) that may be adjusted horizontally, in order to adapt to the anthropometric measurements of the user; said wheels are also equipped with a mechanical brake system (10) that is straightforward and operated manually, and the rear wheels (11) have a much smaller size than the frontal ones and are tied to the frame (12) through a vertical axis (23) which allows a directional 360° rotation, that offers an excellent maneuverability of the element.

Having described this invention, and given its nature and how it can be implemented, the exclusive right and property of the following is claimed:

1. An ergonomic wheelchair with ventral support comprising a structure formed by a cross-linked frame mounted over four wheels, said wheelchair characterized because the front wheels are ergonomically customizable and it integrates with two structures that are linked together; wherein said frame provides support surfaces for a head, a thorax, an abdomen, thighs, legs and arms of a person; wherein the head support surface comprises an articulated arm that ends in a padded ring and is provided with a periscope that includes two separate mirrors placed obliquely; wherein the ventral thoracic support surface is located at an upper end of the frame that is linked by an articulated hinged quadrilateral reticular structure which supports a padded surface adaptable to the anthropometric differences that pivots on its rear end and which angle of inclination can be modified by the action of two gas struts that are operated through a lever; wherein the support surface for the thighs is placed next and comprises a slight tilt on the upper side; the thigh support surface has a padded surface and is attached directly to the frame, provided with removable lateral supports; wherein said support surface can be adjusted in length according to the movement of the tibial support surface below, and comprising a stable padded surface on its upper side located in a semi-horizontal position with a slight inclination towards the front linked to the frame by a quadratic structure.

2. The ergonomic wheelchair with ventral support as a whole according to claim 1, wherein the structures are parallel to one another and cross linked using bars, and wherein each of the structures is formed with a reticule of tubular sections.

3. The ergonomic wheelchair with ventral support as a whole according to claim 1, wherein the support surface for the head is disposed at a position selected from horizontal to inclined.

4. The ergonomic wheelchair with ventral support as a whole according to claim 1, wherein the ventral-thoracic padded support surface presents different densities in the center than on the sides and the gas struts are placed in a vertical position to the frame and are hand-powered by a lever located in front of the armrest.

5. The ergonomic wheelchair with ventral support as a whole according to claim 1, wherein the front wheels are fixed, have thrust rings, and are much larger than the back wheels, and wherein the front wheels are able to move forward or backward over their respective horizontal supports fixed to the frame.

6. The ergonomic wheelchair with ventral support as a whole according to claim 1, wherein the support surface for the head has ventilation holes.
